(19) United States
(12) Patent Application Publication
(10) Pub. No.: US 2008/0306753 A1
(43) Pub. Date: Dec. 11, 2008

(54) System and method for providing quick links

(76) Inventors: Frank Brunswig, Heidelberg (DE); Ramesh B.G., Bangalore (IN); Jan Heiler, Walldorf (DE); Guenter Pecht-Seibert, Muhlhausen (DE); Alexander Rauh, Weinheim (DE); Roy Dipankar, Bangalore (IN); Pradeep Kumar Singh, Bangalore (IN)

Correspondence Address: KENYON & KENYON LLP, ONE BROADWAY, NEW YORK, NY, 10004, US

(21) Appl. No.: 11/811,322

(22) Filed: Jun. 8, 2007

(51) Int. Cl. G06Q 30/00

(52) U.S. Cl. 705/1

(57) ABSTRACT

A method and system are provided for providing a user-interface. The method may include receiving a request to render a business portal at a browser. The method may further include responsive to the request, determining a set of work lists to be rendered on the business portal. The method may further include retrieving a set of quick links corresponding to the set of work lists, wherein each quick link is associated with a work list; transmitting the set of quick links to the browser. The method may further include rendering the set of quick links at the browser to the user on a first screen.

### RELATED TECHNOLOGY

A web-accessible business platform provides an integrated application platform including applications and software necessary for various business processes of an enterprise. The business platform may utilize a business portal to simplify user access by employees over the Internet or other network.

A business portal can provides a single point of access to information. The business portal may include links to various related applications and software. Related applications may relate to various business functions performed by an employee. Applications may include software required by a user to execute his duties, such as accounting or word processing software. Software may include objects that store work lists, which are a set of items to be executed by a user.

The business portal may be generated by aggregating all links needed by a user, where each link leads to an application or a work list. This requires a database query for each work list if the work list objects are stored in a database.

In a web-accessible business portal, web latency time is much greater than database query time. When web latency time is in the hundreds of milliseconds, server response when rendering the business portal quickly becomes unacceptably slow if a large number of work lists must be queried and a result sent to a browser for each over the web.

### BRIEF DESCRIPTION OF THE DRAWINGS

FIG. 1 depicts an example screenshot of a business portal displaying quick links in an enterprise network in accordance with an embodiment of the present invention.

FIG. 2 depicts an example system for providing quick links in accordance with an embodiment of the present invention.

FIG. 3 depicts an example procedure for providing quick links in accordance with an embodiment of the present invention.

### DETAILED DESCRIPTION

A method and system are provided for displaying a plurality of links, or as referred to here, quick links, and counts on a web-accessible business portal, each pair being associated with a work list. For example, the work list may be an object work list (OWL) or an universal work list (UWL) and contain a set of outstanding tasks to be completed by a user. When the business portal is rendered, one request is sent to a database storing the work lists, where a query is executed to retrieve each work list. The entire result is sent to a browser to be displayed to the user as a plurality of quick links.

When a user clicks on the quick link, the system may display a screen associated with the work list. For example, the screen may be a to-do list user interface displaying incomplete tasks if the work list is a to-do list. Alternatively, the work list may be a list of upcoming alerts, a list of notifications and reminders, a list of open items, or a list of completed items.

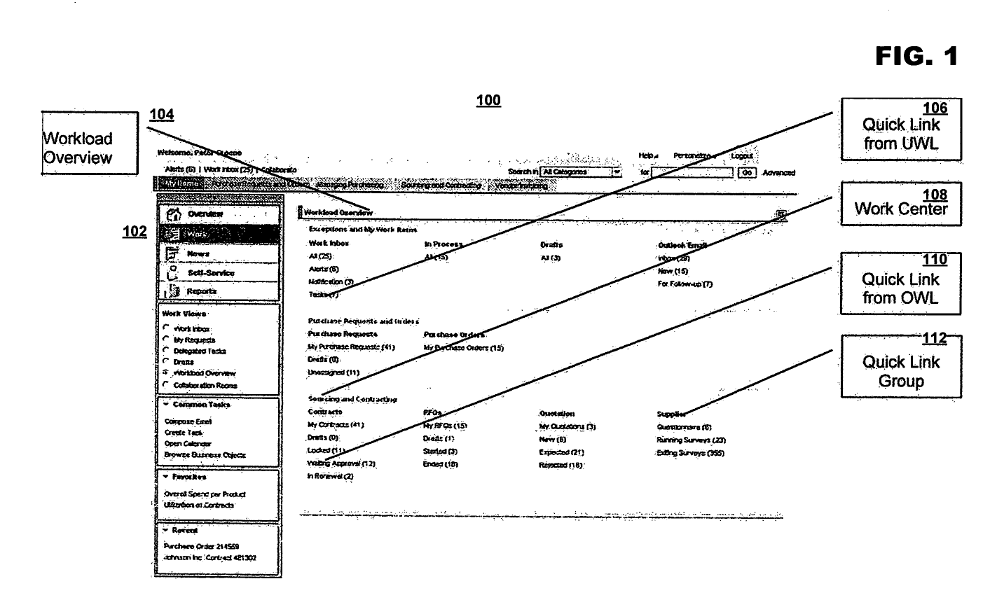

FIG. 1 depicts an example screenshot of a business portal displaying quick links in an enterprise network in accordance with an embodiment of the present invention. The business portal may be web-accessible and be provided to a user by a business platform software executing on a server over the Internet or an enterprise network. The user may view the business portal from a web-complaint browser.

The screen shot 100 may display a business portal 104. The portal, or business portal 104, may provide an overview of the user's customized workspace and provide links to applications and software required by a user to execute his job functions. For example, applications may include productivity software such as accounting or word processing programs. The applications may be web-accessible and execute over a network. The business portal 104 may also provide an overview of work lists associated with the user.

The screen shot 100 may include shortcuts 102, for example, to an overview screen, a work screen, a news screen, a self-service screen, or a reports screen. The shortcuts 102 may lead to other screens besides the business portal 103.

The business portal 104 may display generated quick links and counts. Quick links and counts may be generated from stored work lists and rendered as described later. The quick links may include universal work list quick links 106 and object work list quick links 110.

Quick links may be grouped into work centers 108, where related quick link groups are displayed together. For example, a work center may be predefined and be assigned to the user based on the user's job description. Each work list may be associated with metadata assigning it to a work center 108.

Quick links may be grouped into work centers quick link groups 112, where related quick links are displayed together. Each work list may be associated with metadata assigning it to a quick link group.

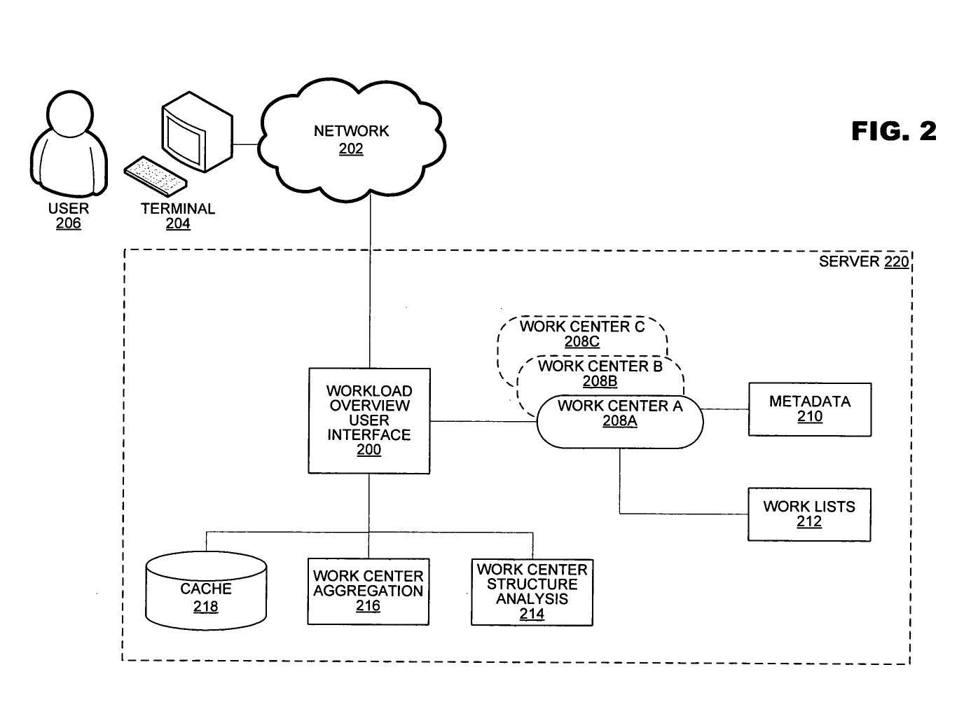

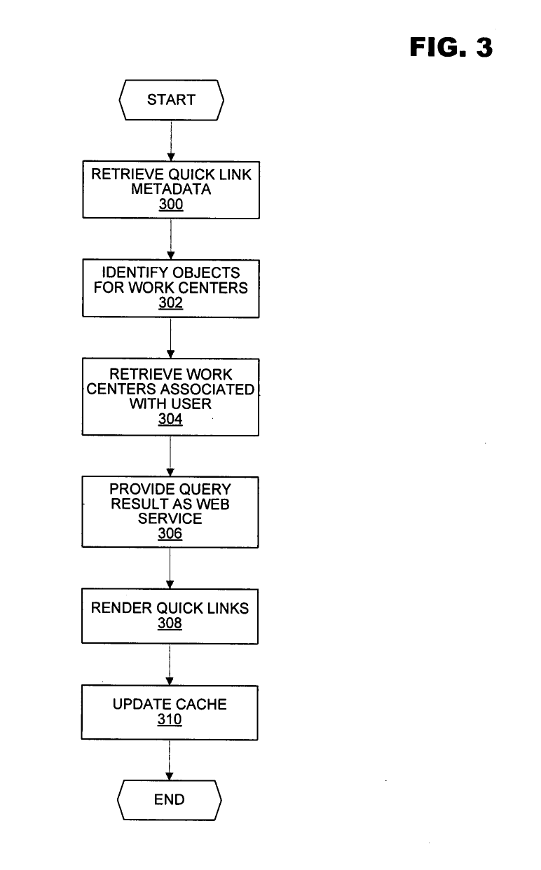

FIG. 2 depicts an example system for providing quick links in accordance with an embodiment of the present invention. For example, the system may be configured to provide a screen shot as depicted in FIG. 1 and execute a procedure as depicted in FIG. 3.

A user 206 may access a terminal 204 and interact with a server 220 over a network 202. The terminal 204 may be a personal computer or other computing device executing a browser. The network 202 may be configured to transmit digital information between the terminal 204 and the server 220.

The server 220 may include a workload overview user interface 200. The user interface 200 may be configured to provide a user interface to the user 206 as depicted in the screenshot of FIG. 1. The user interface 200 may provide a business portal with a plurality of quick links and a count associated with each quick link.

The user interface 200 may access a plurality of work centers 208 stored on an accessible storage medium. It will be appreciated that while only three work centers 208A, 208B, and 208C are depicted, any number of work centers may be stored and accessible to the user interface 200. As described above, each work center may model a business process and provide applications and work lists required by the user in executing the business process.

Each work center may access a set of metadata 210 and a set of work lists 212. The metadata 210 may describe the work center or a work list. For example, work lists may be Universal Work Lists (UWL) or Object Work Lists (OWL). Each work list may include a title and a set of items. For example, a work list may represent a list of outstanding tasks to be completed by a user.

The metadata associated with a work list may also include identifiers associating the work list with a work center and a quick link group, as described above.

It is appreciated that the accessible storage medium may be a database server configured for fast retrieval of information. For example, the database server may receive search queries the user interface 200 and retrieve records corresponding to the search queries.

It is appreciated that the work centers and the metadata may be stored on a read-only server, which mirrors an actual database storing the information. The read-only server may not process any transactions, but perform very fast retrievals.

A quick link may be generated and rendered responsive to a request received by the user interface 200. Alternatively, the quick link may be generated and rendered at a predetermined time, at predetermined intervals, or another trigger event.

The quick link may be retrieved by querying a database storing all work lists 212 in the server 220 for those associated with the user 206. A count indicating a number of items in the quick link may also be retrieved. The quick link may be rendered by the user interface 200 to the user 206 on the terminal 204.

The server 220 may include a work center structure analysis unit 214. The structure analysis unit 214 may analyze a structure of each work center on demand by the user interface 200 or at predetermined times. The structure analysis unit 214 may identify which entities in a work center are work lists, and therefore will be accessed when quick links are rendered to the user 206.

The server 220 may include a work center aggregation unit 216. The aggregation unit 216 may aggregate all work centers associated with or accessible to the user 206 on demand by the user interface 200 or at predetermined times. The aggregation unit 216 may provide aggregate and collect the work lists in each work center that will be accessed when quick links are rendered to the user 206.

The server 220 may include a cache 218. The cache 218 may store a retrieved quick link and associated count for later use. The work lists associated with each work center are known through the structure analysis unit 214 and the aggregation unit 216. If not changed at run time, identifiers of the work lists may be cached to improve performance. For example, quick link titles may be cached. Quick link counts may be changed when the user 206 acts on a work list, for example, by accessing it and checking off a task that has been completed. Quick link counts may be cached, but refreshed whenever the user 206 changes the underlying work list.

It will be appreciated that only one request is necessary from the terminal 204 to the user interface 200, and one response is necessary from the user interface 200 to the terminal 204. Instead of sending out requests for a quick link associated with each work list, an aggregated request is sent from the terminal 204. The aggregated request may include a list of all work lists for which quick links are required. Each work list is then queried by the user interface 200 and each quick link generated, before an aggregated response is sent to the terminal 204.

FIG. 3 depicts an example procedure for providing quick links in accordance with an embodiment of the present invention. For example, the procedure may be executed on a server of a system as depicted in FIG. 2 and display a screenshot as depicted in FIG. 1 to a user.

In 300, the server may retrieve quick link metadata. Quick link metadata may be stored on a rewritable storage medium accessible to the server, for example, over a network. Each user may be associated with a set of quick links, as described below. Each quick link may be associated with metadata such as title, description, etc.

In 302, the server may identify objects of work centers associated with the user. For example, this may be accomplished by a work center structure analysis unit at the server. The user may be an employee registered for access on an enterprise system providing a business platform, and be associated with one or more work centers. Each work center may model a job function of the user and include applications and software necessary for executing the job function. Each work center may be modeled as a software object, which are identified by the server.

In 304, the server may retrieve work center objects associated with the user identified in 302. The work centers may be stored in a database accessible to the server, and each user may be associated with one or more work centers.

Each work center may include one or more work lists, for example, a UWL or an OWL. Work centers associated with the user may be aggregated by a work center aggregation unit 216. For example, the work centers may be aggregated responsive to predetermined trigger events and the results cached for improved performance.

In 306, the server may provide query results as a web service. The list of work centers and associated work lists may be provided over a network to a terminal or another computer as a web service.

In 308, the server may render quick links for the user. The text associated with a title of the work list represented by the quick link may be displayed as a hyperlink on a physical display viewable by the user. Additionally, a count representing a number of items in the work list may also be displayed. For example, the count may represent a number of outstanding tasks to be completed by a user.

In 310, the server may update a cache. A cache may be maintained, storing generated quick link and count, so subsequent requests to render a quick link of a work list may be fulfilled directly from the cache. Ordinary caching methodology may be used, including a timestamp of a generated result and checking the timestamp before using a cache result. Caching may also be implemented as described above.

An example embodiment of the present invention may include a method for providing a user-interface. The method may include receiving a request to render a business portal at a browser. The method may also include, responsive to the request, determining a set of work lists to be rendered on the business portal. The method may also include retrieving a set of quick links corresponding to the set of work lists, wherein each quick link is associated with a work list. The method may also include transmitting the set of quick links to the browser. The method may also include rendering the set of quick links at the browser to the user on a first screen. The method may also include calculating a set of counts corresponding to the set of quick links, wherein each count represents a number of outstanding items associated with a work list. The method may also include rendering the set of counts proximal to the set of quick links. The rendered set of quick links and the rendered set of counts may be aggregated into work centers, each work center corresponding to a user role of the user. The first screen may be personalized by user preferences. The set of quick links and the set of counts may be cached at the browser. A count may represent one of a number of alerts, a number of notifications, a number of open items, and a number of completed items. The work lists may be stored in a server-accessible database.

Another example embodiment of the present invention may include a system for providing a user-interface. The system may include a network configured to carry digital information. The system may also include a terminal executing a browser configured to render a set of quick links in communication with the network. The system may also include a server in communication with the terminal over the network. The server may be configured to receive a request to render a business portal from the browser. The server may also be configured to, responsive to the request, determine a set of work lists to be rendered on the business portal. The server may also be configured to retrieve a set of quick links corresponding to the set of work lists, wherein each quick link is associated with a work list. The server may also be configured to transmit the set of quick links to the browser. The server may also be configured to calculate a set of counts corresponding to the set of quick links, wherein each count represents a number of outstanding items associated with a work list. The browser further may be also configured to render the set of counts proximal to the set of quick links. The rendered set of quick links and the rendered set of counts may be aggregated into work centers, each work center corresponding to a user role of the user. A browser screen rendering the set of quick links may be personalized by user preferences. The system may also include a cache configured to store the set of quick links and the set of counts. A count may represent one of a number of alerts, a number of notifications, a number of open items, and a number of completed items. The system may also include a database accessible to the server, the database configured to store the work lists.

Another example embodiment of the present invention may include a computer-readable medium including instructions adapted to execute a method for providing a user-interface. The method may include receiving a request to render a business portal at a browser. The method may also include, responsive to the request, determining a set of work lists to be rendered on the business portal. The method may also include retrieving a set of quick links corresponding to the set of work lists, wherein each quick link is associated with a work list. The method may also include transmitting the set of quick links to the browser. The method may also include rendering the set of quick links at the browser to the user on a first screen. The method may also include calculating a set of counts corresponding to the set of quick links, wherein each count represents a number of outstanding items associated with a work list. The method may also include rendering the set of counts proximal to the set of quick links. The rendered set of quick links and the rendered set of counts may be aggregated into work centers, each work center corresponding to a user role of the user. The first screen may be personalized by user preferences. The set of quick links and the set of counts may be cached at the browser. A count may represent one of a number of alerts, a number of notifications, a number of open items, and a number of completed items. The work lists may be stored in a server-accessible database.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

What is claimed is:

1. A method for providing a user-interface, comprising:
receiving a request to render a business portal at a browser;
responsive to the request, determining a set of work lists to be rendered on the business portal;
retrieving a set of quick links corresponding to the set of work lists, wherein each quick link is associated with a work list;
calculating a set of counts corresponding to the set of quick links, wherein each count represents a number of outstanding items associated with a work list;
transmitting the set of quick links to the browser; and
rendering the set of quick links and the set of counts at the browser to the user on a first screen.

2. The method of claim 1, wherein the rendered set of quick links and the rendered set of counts are aggregated into work centers, each work center corresponding to a user role of the user.

3. The method of claim 2, wherein the first screen is personalized by user preferences.

4. The method of claim 1, wherein the set of quick links and the set of counts are cached at the browser.

5. The method of claim 1, wherein a count represents one of a number of alerts, a number of notifications, a number of open items, and a number of completed items.

6. The method of claim 1, wherein work lists are stored in a server-accessible database.

7. A system for providing a user-interface, comprising:
a network configured to carry digital information;
a terminal executing a browser configured to render a set of quick links and a set of counts in communication with the network; and
a server in communication with the terminal over the network, the server configured to,
receive a request to render a business portal from the browser,
responsive to the request, determine a set of work lists to be rendered on the business portal,
retrieve a set of quick links corresponding to the set of work lists, wherein each quick link is associated with a work list,
calculate a set of counts corresponding to the set of quick links, wherein each count represents a number of outstanding items associated with a work list, and
transmit the set of quick links to the browser.

8. The system of claim 7, wherein the rendered set of quick links and the rendered set of counts are aggregated into work centers, each work center corresponding to a user role of the user.

9. The system of claim 8, wherein a browser screen rendering the set of quick links is personalized by user preferences.

10. The system of claim 7, further comprising:
a cache configured to store the set of quick links and the set of counts.

11. The system of claim 7, wherein a count represents one of a number of alerts, a number of notifications, a number of open items, and a number of completed items.

12. The system of claim 7, further comprising:
a database accessible to the server, the database configured to store the work lists.

13. A computer-readable medium including instructions adapted to execute a method for providing a user-interface, the method comprising:
receiving a request to render a business portal at a browser;
responsive to the request, determining a set of work lists to be rendered on the business portal;
retrieving a set of quick links corresponding to the set of work lists, wherein each quick link is associated with a work list;
calculating a set of counts corresponding to the set of quick links, wherein each count represents a number of outstanding items associated with a work list;
transmitting the set of quick links to the browser; and
rendering the set of quick links and the set of counts at the browser to the user on a first screen.

14. The medium of claim 13, wherein the rendered set of quick links and the rendered set of counts are aggregated into work centers, each work center corresponding to a user role of the user.

15. The medium of claim 14, wherein the first screen is personalized by user preferences.

16. The medium of claim 13, wherein the set of quick links and the set of counts are cached at the browser.

17. The medium of claim 13, wherein a count represents one of a number of alerts, a number of notifications, a number of open items, and a number of completed items.

18. The medium of claim 13, wherein work lists are stored in a server-accessible database.
